(19) United States
(12) Patent Application Publication
(10) Pub. No.: US 2023/0158922 A1
(43) Pub. Date: May 25, 2023

(54) INFORMATION PROCESSING APPARATUS, METHOD, AND STORAGE MEDIUM

(71) Applicant: TOYOTA JIDOSHA KABUSHIKI KAISHA, Toyota-shi (JP)

(72) Inventor: Ai MIYATA, Sakai-shi (JP)

(21) Appl. No.: 17/937,561

(22) Filed: Oct. 3, 2022

(30) Foreign Application Priority Data
Nov. 24, 2021 (JP) 2021-190458

(51) Int. Cl. B60L 58/13; B60W 30/06; G08G 1/14; G06Q 50/30

(52) U.S. Cl. CPC B60L 58/13; B60W 30/06; G08G 1/148; G06Q 50/30; B60L 2240/60; B60W 2510/244

(57) ABSTRACT

A controlling portion of an information processing apparatus acquires information on the charged state of a vehicle for car sharing from the vehicle via a communication portion. In a case where the vehicle is to be parked in a predetermined parking lot, the controlling portion determines, based on the acquired information on the charged state, whether, among parking spots in the predetermined parking lot, the vehicle is to be parked in a parking spot equipped with the vehicle charger or the vehicle is to be parked in a parking spot not equipped with the vehicle charger.

### CROSS-REFERENCE TO RELATED APPLICATION

This application claims priority to Japanese Patent Application No. 2021-190458 filed on Nov. 24, 2021, incorporated herein by reference in its entirety.

### BACKGROUND

### 1. Technical Field

This disclosure relates to an information processing apparatus, a method, and a storage medium.

### 2. Description of Related Art

In the related art, a technology for charging of a vehicle for car sharing has been known. For example, Japanese Unexamined Patent Application Publication No. 2019-153114 (JP 2019-153114 A) describes a technology to charge a vehicle for car sharing by a charging facility provided in a parking lot.

### SUMMARY

There is room for improvement in the technology for charging of a vehicle for car sharing.

An object of this disclosure accomplished in view of such circumstances is to improve the technology for charging of a vehicle for car sharing.

An information processing apparatus according to one aspect of this disclosure is an information processing apparatus including a controlling portion, and a communication portion. The controlling portion acquires information on a charged state of a vehicle for car sharing from the vehicle via the communication portion. In a case where the vehicle is to be parked in a predetermined parking lot, the controlling portion determines, based on the acquired information on the charged state, whether, among parking spots in the predetermined parking lot, the vehicle is to be parked in a parking spot equipped with a vehicle charger or the vehicle is to be parked in a parking spot not equipped with the vehicle charger.

A method according to one aspect of this disclosure is a method to be executed by an information processing apparatus. The method includes: acquiring information on a charged state of a vehicle for car sharing from the vehicle; and in a case where the vehicle is to be parked in a predetermined parking lot, determining, based on the acquired information on the charged state, whether, among parking spots in the predetermined parking lot, the vehicle is to be parked in a parking spot equipped with a vehicle charger or the vehicle is to be parked in a parking spot not equipped with the vehicle charger.

A storage medium storing a program according to one aspect of this disclosure is a program causing a computer to execute the followings: acquiring information on a charged state of a vehicle for car sharing from the vehicle; and in a case where the vehicle is to be parked in a predetermined parking lot, determining, based on the acquired information on the charged state, whether, among parking spots in the predetermined parking lot, the vehicle is to be parked in a parking spot equipped with a vehicle charger or the vehicle is to be parked in a parking spot not equipped with the vehicle charger.

With one aspect of this disclosure, it is possible to improve the technology for charging of a vehicle for car sharing.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram illustrating a schematic configuration of a system according to one embodiment of this disclosure;

FIG. 2 is a block diagram illustrating a schematic configuration of a vehicle according to one embodiment of this disclosure;

FIG. 3 is a block diagram illustrating a schematic configuration of an information processing apparatus according to one embodiment of this disclosure; and

FIG. 4 is a flowchart illustrating the operation of the information processing apparatus according to one embodiment of this disclosure.

### DETAILED DESCRIPTION OF EMBODIMENTS

The following describes an embodiment of this disclosure.

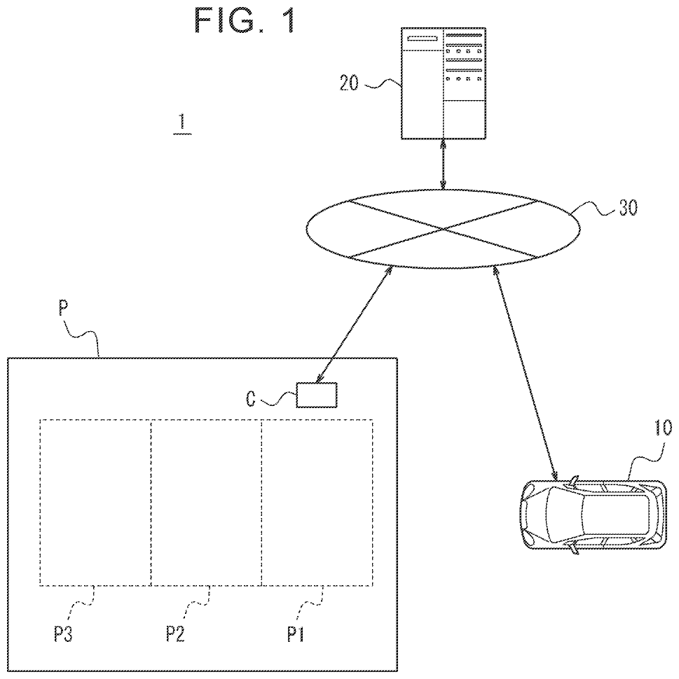

With reference to FIG. 1, the following describes the outline of a system 1 according to the embodiment of this disclosure.

The system 1 includes a vehicle 10 and an information processing apparatus 20. The vehicle 10 and the information processing apparatus 20 are connected to a network 30 communicably.

The vehicle 10 is, for example, an automobile, but the vehicle 10 is not limited to this and may be any vehicle. The automobile is, for example, a gasoline-fueled automobile, a battery electric vehicle, a hybrid electric vehicle, a plug-in hybrid electric vehicle, a fuel cell electric vehicle, or the like. However, the automobile is not limited to them. The vehicle 10 may be driven by a driver or may be driven in a self-driving manner at a given level. The level for the self-driving may be any level from level 1 to level 5 defined by Society of Automotive Engineers (SAE), for example. The vehicle 10 may be a vehicle dedicated for Mobility as a Service (MaaS). Note that the vehicle 10 may include a light vehicle such as a power-assisted bicycle, and furthermore, the vehicle 10 may include a given movable body such as an electrically-driven kickboard that is powered by electricity.

The information processing apparatus 20 is a computer such as a server belonging to a cloud computing system or other computing systems.

The network 30 includes the Internet, at least one wide area network (WAN), at least one metropolitan area network (MAN), or a given combination thereof The network 30 may include at least one wireless network, at least one optical network, or a given combination thereof. The wireless network is, for example, an ad-hoc network, a cellular network, a wireless local area network (LAN), a satellite communications network, or a terrestrial microwave network.

With reference to FIG. 1, the outline of the present embodiment will be described.

A controlling portion 21 of the information processing apparatus 20 acquires information on the charged state of the vehicle 10 for car sharing from the vehicle 10 via a communication portion 22. In a case where the vehicle 10 is to be parked in a predetermined parking lot P, the controlling portion 21 of the information processing apparatus 20 determines, based on the acquired information about the charged state, whether, among parking spots P1 to P3 in the parking lot P, the vehicle 10 is to be parked in the parking spot P1 equipped with a vehicle charger C or the vehicle 10 is to be parked in the parking spot P2 or P3 not equipped with the vehicle charger C.

As such, in the present embodiment, even in the parking lot P in which the number of vehicle chargers C is limited, the vehicle 10 for car sharing that requires charging can be charged appropriately. This accordingly makes it possible to improve the technology for charging of the vehicle 10 for car sharing.

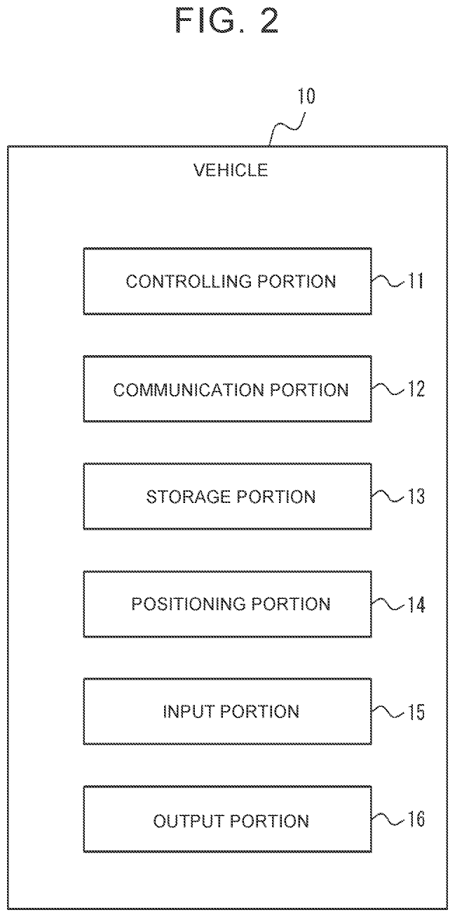

With reference to FIG. 2, the following describes the configuration of the vehicle 10 according to the present embodiment.

The vehicle 10 includes a controlling portion 11, a communication portion 12, a storage portion 13, a positioning portion 14, an input portion 15, and an output portion 16.

The controlling portion 11 includes at least one processor, at least one programmable circuit, at least one dedicated circuit, or a configuration thereof The processor is, for example, a general purpose processor such as a central processing unit (CPU) or a graphics processing unit (GPU), or a dedicated processor that is specialized in a specific process. However, the processor is not limited to them. The programmable circuit is a field-programmable gate array (FPGA), for example, but the programmable circuit is not limited to this. The dedicated processor is an application specific integrated circuit (ASIC), for example, but the dedicated processor is not limited to this. The controlling portion 11 executes a process related to the operation of the vehicle 10 while the controlling portion 11 controls each part of the vehicle 10.

The communication portion 12 includes at least one communications interface. The communications interface corresponds to a mobile communications standard such as 4th-Generation (4G) or 5th-Generation (5G), for example, but the communications interface is not limited to them and may correspond to a given communications standard. The communication portion 12 receives data to be used for the operation of the vehicle 10 and transmits data obtained by the operation of the vehicle 10.

The storage portion 13 includes at least one semiconductor memory, at least one magnetic storage, at least one optical memory, or a combination of any of them. The semiconductor memory is, for example, a random access memory (RAM) or a read only memory (ROM). The RAM is, for example, a static random access memory (SRAM) or a dynamic random access memory (DRAM). The ROM is, for example, an electrically erasable programmable read only memory (EEPROM). The storage portion 13 functions as a main storage device, an auxiliary storage device, or a cache memory, for example. Data to be used for the operation of the vehicle 10 and data obtained by the operation of the vehicle 10 are stored in the storage portion 13. The data to be used for the operation of the vehicle 10 includes a system program, an application program, a database, map information, and so on.

The positioning portion 14 includes one or more global navigation satellite system (GNSS) receivers. The GNSS includes, for example, a global positioning system (GPS), a quasi-zenith satellite system (QZSS), a BeiDou navigation satellite system (BDS), a global navigation satellite system (GLONASS), or Galileo. The positioning portion 14 acquires position information on the vehicle 10.

The input portion 15 includes at least one input interface. The input interface is, for example, a physical key, an electrostatic capacitive key, a pointing device, a touchscreen provided integrally with a display, a microphone, or the like. The input portion 15 detects an input by a user and transmits information on the input to the controlling portion 11. Instead of being provided in the vehicle 10, the input portion 15 may be connected to the vehicle 10 as an external output device. As a connection interface, an interface corresponding to a standard such as a universal serial bus (USB), HDMI (registered trademark), or Bluetooth (registered trademark) can be used, for example.

The output portion 16 includes at least one output interface. The output interface is, for example, a display, a speaker, or the like. The display is, for example, a liquid crystal display (LCD) or an organic electroluminescence (EL) display. The output portion 16 outputs information acquired via the communication portion 12 to a user such as a driver of the vehicle 10 by voice, screen display, or the like. Instead of being provided in the vehicle 10, the output portion 16 may be connected to the vehicle 10 as an external output device. As a connection interface, an interface corresponding to a standard such as a USB, HDMI (registered trademark), or Bluetooth (registered trademark) can be used, for example.

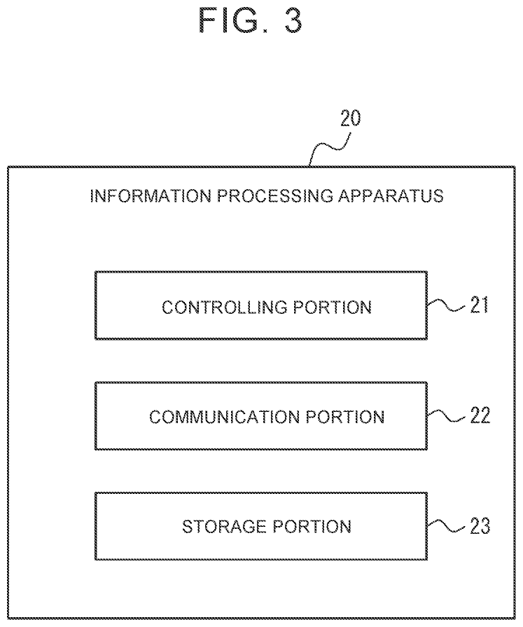

With reference to FIG. 3, the configuration of the information processing apparatus 20 according to the present embodiment will be described.

The information processing apparatus 20 includes the controlling portion 21, the communication portion 22, and a storage portion 23.

The controlling portion 21 includes at least one processor, at least one programmable circuit, at least one dedicated circuit, or a combination of any of them. The processor is a general purpose processor such as a CPU or a GPU, or a dedicated processor specialized in a specific process. The programmable circuit is an FPGA, for example. The dedicated communication circuit is an ASIC, for example. The controlling portion 21 executes a process related to the operation of the information processing apparatus 20 while the controlling portion 21 controls each part of the information processing apparatus 20.

The communication portion 22 includes at least one communications interface. The communications interface corresponds to a mobile communications standard, a wired LAN standard, or a wireless LAN standard, for example. However, the communications interface is not limited to them and may correspond to a given communications standard. The communication portion 22 receives data to be used for the operation of the information processing apparatus 20 and transmits data obtained by the operation of the information processing apparatus 20.

The storage portion 23 includes at least one semiconductor memory, at least one magnetic storage, at least one optical memory, or a combination of any of them. The semiconductor memory is a RAM or a ROM, for example. The RAM is an SRAM or a

DRAM, for example. The ROM is an EEPROM, for example. The storage portion 23 functions as a main storage device, an auxiliary storage device, or a cache memory, for example. Data to be used for the operation of the information processing apparatus 20 and data obtained by the operation of the information processing apparatus 20 are stored in the storage portion 23. In the present embodiment, the data to be used for the operation of the information processing apparatus 20 includes a system program, an application program, a database, map information, and so on.

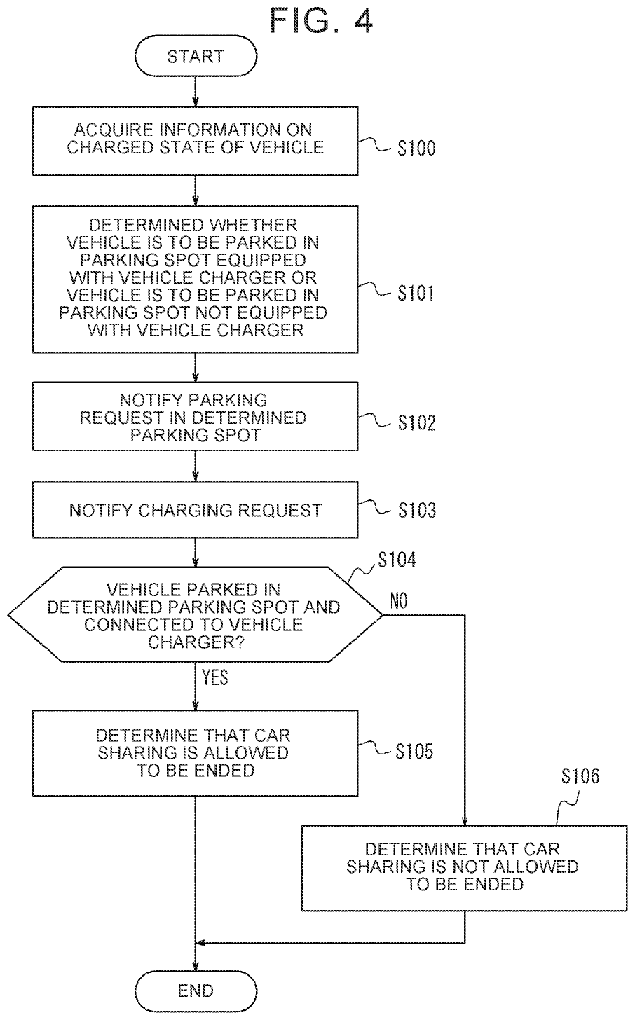

With reference to FIG. 4, the operation of the information processing apparatus 20 according to the present embodiment will be described. This operation corresponds to a method according to one embodiment of this disclosure.

In the present embodiment, in the storage portion 23 of the information processing apparatus 20, information indicative of the vehicle 10 and information indicative of a predetermined parking lot P are stored in advance. The information indicative of the vehicle 10 includes, for example, information described on a number plate, or the like. The information indicative of the predetermined parking lot P includes, for example, position information or the like on a return station for the vehicle 10 that corresponds to the predetermined parking lot P, the return station being registered in advance by a user. Further, the present embodiment describes a case where the vehicle 10 is to be parked in the return station corresponding to the predetermined parking lot P. However, this disclosure is not limited to them.

Step S100: the controlling portion 21 of the information processing apparatus 20 acquires information on the charged state of the vehicle 10 for car sharing from the vehicle 10 via the communication portion 22.

More specifically, the controlling portion 21 of the information processing apparatus 20 acquires position information on the vehicle 10 that is acquired by the positioning portion 14 of the vehicle 10 via the communication portion 22 at predetermined time intervals. When the controlling portion 21 of the information processing apparatus 20 determines, based on the acquired position information on the vehicle 10, that the vehicle 10 is placed within a predetermined distance from the parking lot P, the controlling portion executes the following process. That is, the controlling portion 21 of the information processing apparatus 20 acquires, via the communication portion 22, the state-of-charge (SOC) residual amount of a battery in which electric power for traveling of the vehicle 10 is stored, the SOC residual amount corresponding to information on the charged state of the vehicle 10. Note that the predetermined time interval and the predetermined distance can be set to given values by a company or the like that provides a car sharing service and stored in the storage portion 23 of the information processing apparatus 20 in advance.

Step S101: the controlling portion 21 of the information processing apparatus 20 determines, based on the information on the charged state that is acquired in step S100, whether, among the parking spots P1 to P3 in the parking lot P, the vehicle 10 is to be parked in the parking spot P1 equipped with the vehicle charger C or the vehicle 10 is to be parked in the parking spot P2 or P3 not equipped with the vehicle charger C. Note that the number of parking spots is not limited to this.

More specifically, in a case where the SOC residual amount acquired in step 5100 is equal to or less than a predetermined threshold, the controlling portion 21 of the information processing apparatus 20 determines that the vehicle 10 is to be parked in the parking spot P1 equipped with the vehicle charger C among the parking spots P1 to P3 in the parking lot P. In the meantime, in a case where the SOC residual amount acquired in step S100 exceeds the predetermined threshold, the controlling portion 21 of the information processing apparatus 20 determines that the vehicle 10 is to be parked in the parking spot P2 or P3 not equipped with the vehicle charger C among the parking spots P1 to P3 in the parking lot P. Here, the predetermined threshold can be set to a given value by the company or the like that provides a car sharing service and can be stored in advance in the storage portion 23 of the information processing apparatus 20. Note that, even in a case where the SOC residual amount acquired in step S100 is equal to or less than the predetermined threshold, when the parking spot P1 equipped with the vehicle charger C is occupied, the controlling portion 21 of the information processing apparatus 20 may determine that the vehicle 10 is to be parked in the parking spot P2 or P3 not equipped with the vehicle charger C.

Here, in a case where there are a plurality of vehicles 10 to be parked in the return station corresponding to the predetermined parking lot P, the controlling portion 21 of the information processing apparatus 20 may execute step S101 in the following manner. That is, the controlling portion 21 of the information processing apparatus 20 calculates respective cruising distances of the vehicles 10 by use of pieces of information on respective charged states of the vehicles 10 that are acquired in step S100. The controlling portion 21 of the information processing apparatus 20 calculates respective priority levels of the vehicles 10 for parking in the parking spot P1 equipped with the vehicle charger C, based on the calculated cruising distances. The controlling portion 21 of the information processing apparatus 20 then determines which one of the vehicles 10 is to be parked in the parking spot P1 equipped with the vehicle charger C, based on the comparison between the calculated priority levels. More specifically, the controlling portion 21 of the information processing apparatus 20 calculates respective cruising distances of the vehicles 10 by use of respective SOC residual amounts of the vehicles 10 and determines that the vehicle 10 with the shortest cruising distance is preferentially to be parked in the parking spot P1 equipped with the vehicle charger C, for example.

The following steps describe details of a process to be executed in a case where the SOC residual amount of the vehicle 10 is equal to or less than the predetermined threshold, and the parking spot P1 equipped with the vehicle charger C is vacant.

Step S102: the controlling portion 21 of the information processing apparatus 20 notifies, via the communication portion 22, a user of the vehicle 10 of a parking request to park the vehicle 10 in the parking spot P1 determined in step S101.

More specifically, the controlling portion 21 of the information processing apparatus 20 generates information indicative of the parking request to park the vehicle 10 in the parking spot P1 determined in step S101. The controlling portion 21 of the information processing apparatus 20 transmits the generated information indicative of the parking request to the vehicle 10 via the communication portion 22. When the controlling portion 11 of the vehicle 10 receives the information indicative of the parking request from the information processing apparatus 20 via the communication portion 12, the controlling portion 11 outputs the information indicative of the parking request to the user of the vehicle 10 by screen display, voice, or the like via the output portion 16. For example, the information indicative of the parking request may include a message that promotes parking in the parking spot P1 determined in step S101, e.g., “Please park the vehicle in the parking spot P1.” Instead of this, in step S102, the controlling portion 21 of the information processing apparatus 20 may transmit, to a given user terminal such as a smartphone via the communication portion 22, the information indicative of the parking request to park the vehicle 10 in the parking spot P1 equipped with the vehicle charger C that is determined in step S101. In this case, the information indicative of the parking request to park the vehicle 10 in the parking spot P1 determined in step S101 may be displayed on a display screen of an application program related to a car sharing service, the application program being operated on the user terminal, for example.

Step S103: the controlling portion 21 of the information processing apparatus 20 notifies, via the communication portion 22, the user of the vehicle 10 of a charging request to charge the vehicle 10 by the vehicle charger C provided in the parking spot P1 determined in step S101.

More specifically, the controlling portion 21 of the information processing apparatus 20 generates information indicative of the charging request to charge the vehicle 10 by the vehicle charger C provided in the parking spot P1 determined in step S101. The controlling portion 21 of the information processing apparatus 20 transmits the generated information indicative of the charging request to the vehicle 10 via the communication portion 22. When the controlling portion 11 of the vehicle 10 receives the information indicative of the charging request from the information processing apparatus 20 via the communication portion 12, the controlling portion 11 outputs the information indicative of the charging request to the user of the vehicle 10 by screen display, voice, or the like via the output portion 16. For example, the information indicative of the charging request may include a message that promotes charging by the vehicle charger C provided in the parking spot P1 determined in step S101, e.g., “Please charge the vehicle by the vehicle charger C in the parking spot P1.” Instead of this, in step S103, the controlling portion 21 of the information processing apparatus 20 may transmit, to a given user terminal such as a smartphone via the communication portion 22, the information indicative of the charging request to charge the vehicle 10 by the vehicle charger C provided in the parking spot P1 determined in step S101. In this case, the information indicative of the charging request to charge the vehicle 10 by the vehicle charger C provided in the parking spot P1 determined in step S101 may be displayed on the display screen of the application program related to the car sharing service, the application program being operated on the user terminal, for example.

Note that the parking request in step S102 and the charging request in step S103 may be performed as a single notification.

Step S104: the controlling portion 21 of the information processing apparatus 20 determines whether or not the vehicle 10 is parked in the parking spot P1 determined in step S101 and the vehicle 10 is connected to the vehicle charger C provided in the parking spot P1 determined in step S101. In a case where the controlling portion 21 of the information processing apparatus 20 determines that the vehicle 10 is parked in the parking spot P1 determined in step S101 and the vehicle 10 is connected to the vehicle charger C provided in the parking spot P1 determined in step S101, the process proceeds to step S105. In the meantime, in a case where the controlling portion 21 of the information processing apparatus 20 determines that the vehicle 10 is not parked in the parking spot P1 determined in step S101 and the vehicle 10 is not connected to the vehicle charger C provided in the parking spot P1 determined in step S101, the process proceeds to step S106.

More specifically, the controlling portion 21 of the information processing apparatus 20 determines, based on image data on the parking lot P including the vehicle 10, the parking spots P1 to P3, and the vehicle charger C, the image data being acquired from a given camera provided in the parking lot P via the communication portion 22, whether or not the vehicle 10 is parked in the parking spot P1 determined in step S101 and the vehicle 10 is connected to the vehicle charger C provided in the parking spot P1 determined in step S101. Instead of this, the controlling portion 21 of the information processing apparatus 20 may determine whether or not the vehicle 10 is parked in the parking spot P1 determined in step S101, based on a radio wave of Bluetooth (registered trademark) or the like that can be transmitted or received by a given sensor provided in the vehicle 10 and given sensors provided in the parking spots P1 to P3. In this case, the controlling portion 21 of the information processing apparatus 20 may determine whether or not the vehicle 10 is connected to the vehicle charger C provided in the parking spot P1 determined in step S101, based on a signal indicative of connection to the vehicle charger C that has been detected by the vehicle 10 or a signal indicative of connection to the vehicle 10 that has been detected by the vehicle charger C, the connection signals being receivable via the communication portion 22.

Step S105: the controlling portion 21 of the information processing apparatus 20 determines that the use of the car sharing is allowed to be ended.

More specifically, the controlling portion 21 of the information processing apparatus 20 determines that the use of the car sharing is allowed to be ended, and the controlling portion 21 generates an end permission notification. Then, the controlling portion 21 of the information processing apparatus 20 transmits the generated end permission notification to the vehicle 10 via the communication portion 22. When the controlling portion 11 of the vehicle 10 receives the end permission notification from the information processing apparatus 20 via the communication portion 12, the controlling portion 11 outputs the end permission notification to the user of the vehicle 10 by screen display, voice, or the like via the output portion 16. For example, the end permission notification may include a message, e.g., “The car sharing service is ended. Thank you for using our service.” Instead of this, in step S105, the controlling portion 21 of the information processing apparatus 20 may transmit, via the communication portion 22, the end permission notification to a given user terminal such as a smartphone. In this case, the end permission notification may be displayed on the display screen of the application program related to the car sharing service, the application program being operated on the user terminal, for example.

Step S106: the controlling portion 21 of the information processing apparatus 20 determines that the use of the car sharing is not allowed be ended.

More specifically, the controlling portion 21 of the information processing apparatus 20 determines that the use of the car sharing is not allowed to be ended, and the controlling portion 21 generates an end non-permission notification. Then, the controlling portion 21 of the information processing apparatus 20 transmits the generated end non-permission notification to the vehicle 10 via the communication portion 22. When the controlling portion 11 of the vehicle 10 receives the end non-permission notification from the information processing apparatus 20 via the communication portion 12, the controlling portion 11 outputs the end non-permission notification to the user of the vehicle 10 by screen display, voice, or the like via the output portion 16. For example, the end non-permission notification may include a message to promote charging in the parking spot P1 determined in step S101, e.g., “The car sharing service cannot be ended. Please park and charge the vehicle in the specified parking spot P1.” Instead of this, in step S106, the controlling portion 21 of the information processing apparatus 20 may transmit, via the communication portion 22, the end non-permission notification to a given user terminal such as a smartphone. In this case, the end non-permission notification may be displayed on the display screen of the application program related to the car sharing service, the application program being operated on the user terminal, for example.

The above description deals with the process to be executed in a case where the SOC residual amount of the vehicle 10 is equal to or less than the predetermined threshold, and the parking spot P1 equipped with the vehicle charger C is vacant. Note that a process to be executed when the SOC residual amount of the vehicle 10 exceeds a predetermined threshold in step S101 can be executed as follows. That is, similarly to step S102, the controlling portion 21 of the information processing apparatus 20 notifies the user of the vehicle 10 of a parking request to park the vehicle 10 in the parking spot P2 or P3 not equipped with the vehicle charger C. Then, when the controlling portion 21 of the information processing apparatus 20 determines that the vehicle 10 is parked in the parking spot P2 or P3, the controlling portion 21 of the information processing apparatus 20 determines that the use of the car sharing is allowed to be ended, and the controlling portion 21 notifies the user of the vehicle 10 that the use of the car sharing is allowed to be ended, similarly to step S105. In the meantime, when the controlling portion 21 of the information processing apparatus 20 determines that the vehicle 10 is not parked in the parking spot P2 or P3, the controlling portion 21 of the information processing apparatus 20 determines that the use of the car sharing is not allowed to be ended, similarly to step S106, and the controlling portion 21 notifies the user of the vehicle 10 of a message to promote parking in the parking spot P2 or P3, e.g., “The car sharing service cannot be ended. Please park the vehicle in the specified parking spot P2 (or P3).”

As has been described earlier, the controlling portion 21 of the information processing apparatus 20 according to the present embodiment acquires information on the charged state of the vehicle 10 for the car sharing from the vehicle 10 via the communication portion 22. In a case where the vehicle 10 is to be parked in the predetermined parking lot P, the controlling portion 21 of the information processing apparatus 20 determines, based on the acquired information on the charged state, whether, among the parking spots P1 to P3 in the parking lot P, the vehicle 10 is to be parked in the parking spot P1 equipped with the vehicle charger C or the vehicle 10 is to be parked in the parking spot P2 or P3 not equipped with the vehicle charger C.

With such a configuration, even in the parking lot P in which the number of vehicle chargers C is limited, the vehicle 10 for car sharing that requires charging can be charged appropriately. This accordingly makes it possible to improve the technology for charging of the vehicle 10 for car sharing.

This disclosure is described based on the drawings and the embodiment, but it should be noted that a person skilled in the art can easily make various modifications and alterations based on this disclosure. Accordingly, it should be noted that these modifications and alterations are included in the scope of this disclosure. For example, the constituents, functions or the like included the steps, or the like can be rearranged within a range where the rearrangement is not logically inconsistent with the above embodiment, and a plurality of constituents, steps, or the like may be combined into one or may be divided.

As one modification, the configuration and the operation of the information processing apparatus 20 may be dispersed in a plurality of computers communicable with each other. Further, for example, some of or all of the constituents of the information processing apparatus 20 may be provided in the vehicle 10. For example, a car navigation device provided in the vehicle 10 may include some or all of the constituents of the information processing apparatus 20.

Further, as one modification, instead of steps S104 to S106, in a case where the controlling portion 21 of the information processing apparatus 20 determines that the vehicle 10 is parked in the parking spot P1 determined in step S101, the controlling portion 21 of the information processing apparatus 20 may determine that the use of the car sharing is allowed to be ended. More specifically, the controlling portion 21 of the information processing apparatus 20 determines whether or not the vehicle 10 is parked in the parking spot P1 determined in step S101, based on image data of the parking lot P including the vehicle 10 and the parking spots P1 to P3, the image data being acquired from a given camera provided in the parking lot P via the communication portion 22. Instead of this, the controlling portion 21 of the information processing apparatus 20 may determine whether the vehicle 10 is parked in the parking spot P1 determined in step S101, based on a radio wave of Bluetooth (registered trademark) or the like that can be transmitted or received by a given sensor provided in the vehicle 10 and given sensors provided in the parking spots P1 to P3. The descriptions about steps S105, S106 in the above embodiment can be applied to the subsequent process.

Further, as one modification, the controlling portion 21 of the information processing apparatus 20 may notify, via the communication portion 22, a parking request to the user of the vehicle 10 from which information on its charged state is not obtainable among the vehicles 10 for car sharing, the parking request being a request to park the vehicle 10 in the parking spot P2 or P3 not equipped with the vehicle charger C. More specifically, the controlling portion 21 of the information processing apparatus 20 notifies, via the communication portion 22, the parking request to park the vehicle 10 in the parking spot P2 or P3 not equipped with the vehicle charger C to the user of the vehicle 10 such as a gasoline-fueled automobile from which its SOC residual amount is not obtainable from among the vehicles 10 for car sharing, similarly to step S102. Hereby, the user of the vehicle 10 such as a gasoline-fueled automobile that does not require charging can be promoted to park the vehicle 10 in the parking spot P2 or P3 not equipped with the vehicle charger C.

Further, as one modification, a general-purpose computer may be functionalized as the information processing apparatus 20 according to the embodiment. More specifically, a program in which the process content to implement each function of the information processing apparatus 20 according to the embodiment is described is stored in a memory of the general-purpose computer and read and executed by a processor. Accordingly, this disclosure is also achievable as a program executable by a processor or a non-transitory computer readable storage medium in which the program is stored.

What is claimed is:

1. An information processing apparatus comprising:
a controlling portion; and
a communication portion, wherein:
the controlling portion acquires information on a charged state of a vehicle for car sharing from the vehicle via the communication portion; and
in a case where the vehicle is to be parked in a predetermined parking lot, the controlling portion determines, based on the acquired information on the charged state, whether, among parking spots in the predetermined parking lot, the vehicle is to be parked in a parking spot equipped with a vehicle charger or the vehicle is to be parked in a parking spot not equipped with the vehicle charger.

2. The information processing apparatus according to claim 1, wherein the controlling portion notifies, via the communication portion, a user of the vehicle of a parking request to park the vehicle in the determined parking spot.

3. The information processing apparatus according to claim 1, wherein, in a case where the controlling portion determines that the vehicle is to be parked in the parking spot equipped with the vehicle charger, the controlling portion notifies, via the communication portion, a user of the vehicle of a charging request to charge the vehicle by the vehicle charger provided in the determined parking spot.

4. The information processing apparatus according to claim 1, wherein, when the controlling portion determines that the vehicle is parked in the determined parking spot, the controlling portion determines that use of the car sharing is allowed to be ended.

5. The information processing apparatus according to claim 1, wherein:
in a case where the controlling portion determines that the vehicle is to be parked in the parking spot equipped with the vehicle charger, when the controlling portion determines that the vehicle is parked in the determined parking spot and the vehicle is connected to the vehicle charger provided in the determined parking spot, the controlling portion determines that use of the car sharing is allowed to be ended.

6. The information processing apparatus according to claim 1, wherein:
the controlling portion calculates respective priority levels of vehicles for parking in the parking spot equipped with the vehicle charger, based on respective cruising distances of the vehicles, the cruising distances being calculated by use of pieces of information on respective charged states of the vehicles; and
the controlling portion determines which one of the vehicles is to be parked in the parking spot equipped with the vehicle charger, based on a comparison between the calculated priority levels.

7. The information processing apparatus according to claim 1, wherein the controlling portion notifies, via the communication portion, a parking request to a user of a vehicle from which information on a charged state of the vehicle is not obtainable among vehicles, the parking request being a request to park the vehicle in the parking spot not equipped with the vehicle charger.

8. A method to be executed by an information processing apparatus, the method comprising:
acquiring information on a charged state of a vehicle for car sharing from the vehicle; and
in a case where the vehicle is to be parked in a predetermined parking lot, determining, based on the acquired information on the charged state, whether, among parking spots in the predetermined parking lot, the vehicle is to be parked in a parking spot equipped with a vehicle charger or the vehicle is to be parked in a parking spot not equipped with the vehicle charger.

9. The method according to claim 8, further comprising notifying a user of the vehicle of a parking request to park the vehicle in the determined parking spot.

10. The method according to claim 8, further comprising, in a case where it is determined that the vehicle is to be parked in the parking spot equipped with the vehicle charger, notifying a user of the vehicle of a charging request to charge the vehicle by the vehicle charger provided in the determined parking spot.

11. The method according to claim 8, further comprising, when it is determined that the vehicle is parked in the determined parking spot, determining that use of the car sharing is allowed to be ended.

12. The method according to claim 8, further comprising, in a case where it is determined that the vehicle is to be parked in the parking spot equipped with the vehicle charger, when it is determined that the vehicle is parked in the determined parking spot and the vehicle is connected to the vehicle charger provided in the determined parking spot, determining that use of the car sharing is allowed to be ended.

13. The method according to claim 8, further comprising:
calculating respective priority levels of vehicles for parking in the parking spot equipped with the vehicle charger, based on respective cruising distances of the vehicles, the cruising distances being calculated by use of pieces of information on respective charged states of the vehicles; and
determining which one of the vehicles is to be parked in the parking spot equipped with the vehicle charger, based on a comparison between the calculated priority levels.

14. The method according to claim 8, further comprising notifying a parking request to a user of a vehicle from which information on a charged state of the vehicle is not obtainable among vehicles, the parking request being a request to park the vehicle in the parking spot not equipped with the vehicle charger.

15. A non-transitory storage medium storing a program causing a computer to execute the followings:
acquiring information on a charged state of a vehicle for car sharing from the vehicle; and
in a case where the vehicle is to be parked in a predetermined parking lot, determining, based on the acquired information on the charged state, whether, among parking spots in the predetermined parking lot, the vehicle is to be parked in a parking spot equipped with a vehicle charger or the vehicle is to be parked in a parking spot not equipped with the vehicle charger.

16. The non-transitory storage medium according to claim 15, wherein the program further causes the computer to execute notifying a user of the vehicle of a parking request to park the vehicle in the determined parking spot.

17. The non-transitory storage medium according to claim 15, wherein the program further causes the computer to execute, in a case where it is determined that the vehicle is to be parked in the parking spot equipped with the vehicle charger, notifying a user of the vehicle of a charging request to charge the vehicle by the vehicle charger provided in the determined parking spot.

18. The non-transitory storage medium according to claim 15, wherein the program further causes the computer to execute, when it is determined that the vehicle is parked in the determined parking spot, determining that use of the car sharing is allowed to be ended.

19. The non-transitory storage medium according to claim 15, wherein the program further causes the computer to execute, in a case where it is determined that the vehicle is to be parked in the parking spot equipped with the vehicle charger, when it is determined that the vehicle is parked in the determined parking spot and the vehicle is connected to the vehicle charger provided in the determined parking spot, determining that use of the car sharing is allowed to be ended.

20. The non-transitory storage medium according to claim 15, wherein the program further causes the computer to execute:
calculating respective priority levels of vehicles for parking in the parking spot equipped with the vehicle charger, based on respective cruising distances of the vehicles, the cruising distances being calculated by use of pieces of information on respective charged states of the vehicles; and
determining which one of the vehicles is to be parked in the parking spot equipped with the vehicle charger, based on a comparison between the calculated priority levels.
